(19) United States
(12) Patent Application Publication
(10) Pub. No.: US 2025/0273881 A1
(43) Pub. Date: Aug. 28, 2025

(54) TERMINAL BLOCK AND TERMINAL BASE

(71) Applicant: Monitor Audio Ltd, Rayleigh (GB)

(72) Inventors: Christopher Adam STRICKLAND, Rayleigh (GB); Matthew Alexander Robert SHARP, Rayleigh (GB); Charles Edward MINETT, Rayleigh (GB)

(21) Appl. No.: 19/205,852

(22) Filed: May 12, 2025

Related U.S. Application Data
(63) Continuation of application No. PCT/GB2023/052979, filed on Nov. 14, 2023.

(30) Foreign Application Priority Data
Nov. 14, 2022 (GB) 2216966.8

(51) Int. Cl. H01R 9/24; H04R 1/06

(52) U.S. Cl. CPC H01R 9/2416; H04R 1/06; H04R 2201/021; H04R 2420/09

(57) ABSTRACT

The present invention relates to a terminal block for connection with a terminal base to provide an electrical signal and a terminal base for connection with a terminal block to receive an electrical signal. The terminal block comprises a housing configured to couple with the terminal base of the loudspeaker. The housing comprises at least two wire-securing terminals each arranged to receive and secure a wire, each of which are in electrical communication with an electrical contact for transmitting the electrical signal to a respective electrical contact of the loudspeaker when the terminal block is coupled with the terminal base, a magnetic material for magnetically attracting the terminal block to the terminal base, and a locking mechanism comprising a locking element for releasably engaging with a locking element of the terminal base. The terminal base comprises a housing configured to couple with the terminal block.

### CROSS-REFERENCE TO RELATED APPLICATIONS

This application is a continuation under 35 U.S.C. § 120 of International Application No. PCT/GB2023/052979, filed Nov. 14, 2023, which claims priority to United Kingdom Application No. GB 2216966.8, filed Nov. 14, 2022 under 35 U.S.C. § 119(a). Each of the above-referenced patent applications is incorporated by reference in its entirety.

### FIELD OF INVENTION

This invention generally relates to a terminal block for connection with a terminal base to provide an electrical signal and a terminal base for connection with a terminal block to receive an electrical signal and particularly, although not exclusively, to a terminal block and terminal base of a loudspeaker.

### BACKGROUND

In-ceiling and in-wall audio speakers and systems offer a simple and elegant solution to both commercial and home environments, providing high quality audio with rich sound and minimal visual impacts. However, the installation process can be difficult and time-consuming.

Many loudspeakers in the industry utilise spring-loaded terminals for connecting the cable to the loudspeakers. With the spring-loaded terminals, the installer needs to push down the terminal by applying a force, insert the cable to the terminal and release the force thereby securing the cable in the terminal. The use of spring-loaded terminal allows a faster connection of the cables with the loudspeaker, in comparison to terminals with other mechanisms such as screw terminals.

However, the spring-loaded terminals create difficulty during the fitment of the loudspeakers into the ceiling as the installer has to hold the loudspeaker in one hand whilst also pushing the terminal down and inserting the wire with the other hand, which is not a simple set of actions. Not only is this set of actions tricky to perform, it also carries a risk of damage and injury to the loudspeaker and installer.

### SUMMARY

In the light of the foregoing background, it is an object to address the above needs, to overcome or substantially ameliorate the above disadvantages or, more generally, to provide a loudspeaker with a terminal base and a terminal block for easy and quick connection while simplifying and allowing a safe installation process.

The above object is addressed by the combination of features of the main claims; the dependent claims disclose further advantageous embodiments of the invention.

One skilled in the art will derive from the following description other objects of the invention. Therefore, the foregoing statements of object are not exhaustive and serve merely to illustrate some of the many objects of the present invention.

In one aspect of the present invention, there is provided a terminal block for connection with a terminal base of a loudspeaker to provide an electrical signal to the loudspeaker, comprising a housing configured to couple with the terminal base of the loudspeaker. The housing comprising at least two wire-securing terminals each arranged to receive and secure a wire, each of the at least two wire-securing terminals in electrical communication with an electrical contact for transmitting the electrical signal to a respective electrical contact of the loudspeaker when the terminal block is coupled with the terminal base, a magnetic material for magnetically attracting the terminal block to the terminal base, and a locking mechanism comprising a locking element for releasably engaging with a locking element of the terminal base.

Preferably, the locking element of the terminal block is moveable between an open position and a closed position, wherein in the open position the locking element is not locked with the terminal base of the loudspeaker, and in the closed position the locking element is locked with the terminal base of the loudspeaker.

Conveniently, the locking element comprises a single jaw or a pair of jaws pivotally mounted to the housing, each of the jaws comprising an engagement projection arranged to engage with the locking element of the terminal base.

Advantageously, the engagement projection comprises an abutment surface to facilitate the locking element to move from the closed position towards the open position during coupling with the locking element of the terminal base.

Preferably, the jaws are biased to the closed position.

Conveniently, the magnetic material is a magnet or a ferromagnetic material.

Advantageously, the housing of the terminal block comprises a cavity arranged to couple with a protrusion of the terminal base having a complementary shape.

Preferably, the magnetic material is disposed within the cavity of the housing.

In accordance with another aspect of the present invention, there is provided a terminal base of a loudspeaker for connection with a terminal block to receive an electrical signal, comprising a housing configured to couple with the terminal block, the housing comprising at least two electrical contacts each configured to receive an electrical signal from a respective electrical contact of the terminal block when the terminal base is coupled with the terminal block, a magnetic material for magnetically attracting the terminal block, and a locking mechanism comprising a locking element for releasably engaging with a locking element of the terminal block.

Preferably, the locking element of the terminal base comprises a slot dimensioned to receive the locking element of the terminal block.

Conveniently, the housing defines a protrusion arranged to couple with a cavity of the terminal block having a complementary shape.

Advantageously, the protrusion comprises a distal portion, wherein the magnet and the at least two electrical contact are disposed on the distal portion of the protrusion.

In accordance with another aspect of the present invention, there is provided a loudspeaker comprising a terminal assembly, the terminal assembly comprising a terminal block and a terminal base, wherein the magnetic material of one of the terminal block and the terminal base comprises a magnet.

In accordance with a further aspect of the present invention, there is provided a method of installing a loudspeaker, comprising the steps of: providing a wire to the wire-securing terminal of the terminal block and securing the wire therein; providing the terminal base of the loudspeaker in close proximity to the terminal block such that the magnetic material of the terminal base and the terminal block magnetically attract each other to facilitate the coupling of the terminal base with the terminal block to bring the respective electrical contacts into electrical communication with each other.

Preferably, the locking element of the terminal block engages with the locking element of the terminal base of the loudspeaker when the terminal base is coupled with the terminal block to lock the terminal block and the terminal base together.

Other aspects of the invention will become apparent by consideration of the detailed description and accompanying drawings.

### BRIEF DESCRIPTION OF DRAWINGS

The foregoing and further features of the present invention will now be described, by way of example, with reference to the accompanying drawings in which:

FIG. 1 is a perspective view of a loudspeaker having a terminal assembly.

FIG. 2A is a perspective view of a terminal block.

FIG. 2B is another perspective view of the terminal block.

FIG. 3 is a cross-sectional view of the terminal block with the locking mechanism visible in this view.

FIG. 4A and 4B are cross-sectional views of the terminal block of FIG. 2 where the locking element is in the closed and open position respectively.

FIG. 5 is a perspective view of the terminal base for connection with the terminal base of FIG. 1A.

FIGS. 6A to 6C are perspective view of the loudspeaker illustrating a method of installing the loudspeaker.

### DETAILED DESCRIPTION

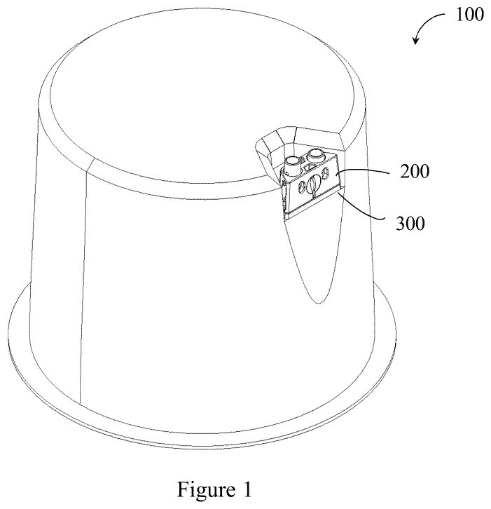

FIG. 1 shows a loudspeaker 100 having a terminal assembly, with the terminal assembly comprising a terminal block 200 and a terminal base 300. Each of the terminal block 200 and the terminal base 300 will be discussed in more detail below.

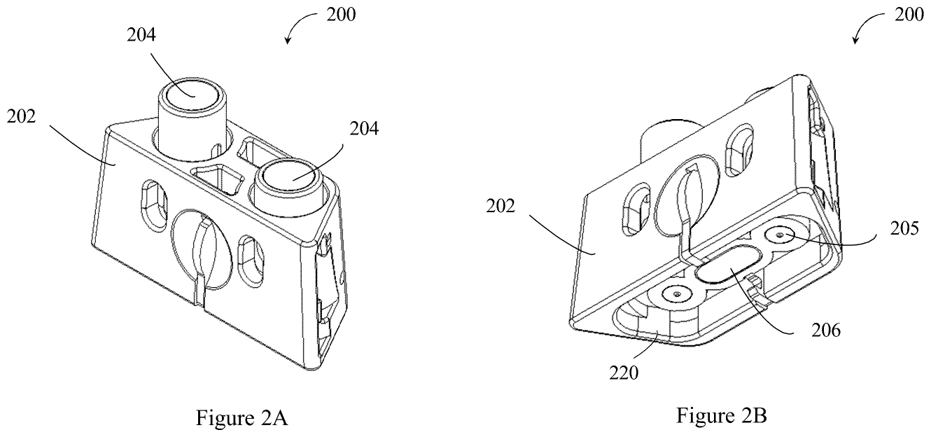

FIGS. 2A and 2B show a perspective view of a terminal block 200 of the loudspeaker 100 according to one embodiment of the invention. The terminal block 200 is configured for connection with a terminal base 300 of a loudspeaker 100 to provide an electrical signal to the loudspeaker 100, particularly an in-ceiling or in-wall loudspeaker. Although the application of the terminal block and terminal base is used with a loudspeaker according to this embodiment of the invention, the terminal block and terminal base can also be applied to other electronic devices, especially other big, heavy devices where installation requires holding the heavy device in one hand while connecting wires and/or cables to it.

The terminal block 200 of FIGS. 2A and 2B comprises a housing 202 configured to couple with the terminal base 300 of the of loudspeaker 100. In this embodiment, the housing 202 is made of plastic but could also be made of other materials. The housing 202 has two wire-securing terminals 204 each arranged to receive and secure a wire. Each of the two wire-securing terminals 204 are in electrical communication with an electrical contact for transmitting the electrical signal to a respective electrical contact of the loudspeaker 100 when the terminal block 200 is coupled with the terminal base 300. In this embodiment, the wire-securing terminals 204 are spring-loaded push terminals commonly used in the industry, but in other embodiments, other wire retaining mechanisms can be used such as a screw clamp terminal. There may also be more than two wire-securing terminals, for example, four or six wire-securing terminals. Each of the wire is arranged to transmit analog and/or digital audio signals, and optionally power to the loudspeaker 100 through the terminal block 300.

The housing 202 further has a magnetic material 206 for magnetically attracting the terminal block 200 to the terminal base 300. Preferably, the magnetic material 206 is a magnet such as a neodymium magnet or a plastic resin magnet. In some other embodiments, the magnetic material 206 is a ferromagnetic material. Examples of such ferromagnetic material include but are not limited to steel, nickel, cobalt and their alloys which can be attracted to a magnet on the terminal base of the loudspeaker. Using a magnet, particularly a neodymium magnet, offers a strong magnetic attraction between the terminal block 200 and the terminal base 300, thus allowing a quick, time-saving connection. The magnetic attraction between the magnetic materials in the terminal block and the terminal base bring them into contact with each other to facilitate installation. This brings the respective electrical contacts together so that electrical signals can pass from the wires or cables, through the terminal block and into the terminal housing to allow the loudspeaker to function. For the desired magnetic attraction between the two parts, at least one of the terminal block and terminal base must contain a magnet. So, if one of the terminal block and the terminal base contains a magnet, the other must either contain another magnet (arranged so they attract each other), or material that would be attracted by the magnet (i.e. ferromagnetic material such as steel etc).

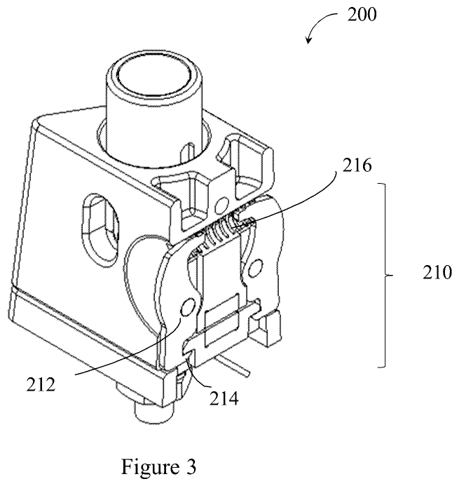

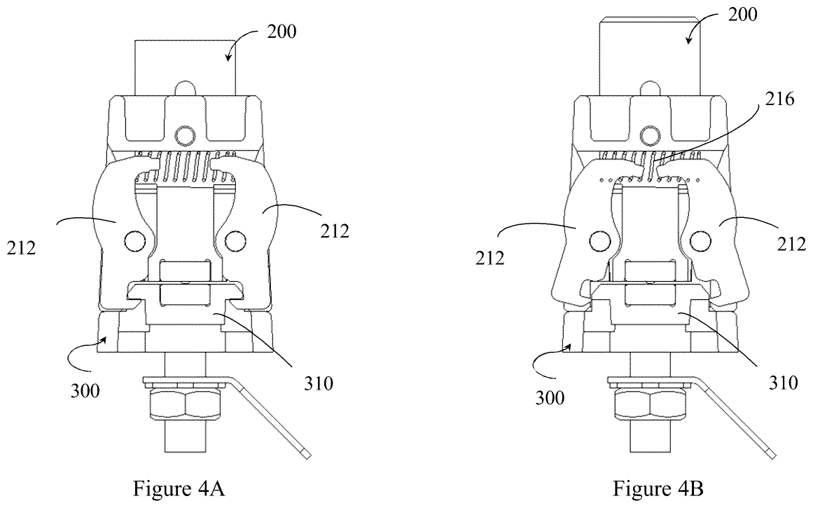

As shown in FIG. 3, the housing 202 further has a locking mechanism 210 comprising a locking element 212 for releasably engaging with a locking element 312 of the terminal base 300. The locking element 212 of the terminal block 200 is moveable between a closed position and an open position, as shown in FIGS. 4A and 4B respectively. In the open position, the locking element 212 is not locked with the terminal base 300 of the loudspeaker 100, and in the closed position the locking element 212 is locked with the terminal base 300 of the loudspeaker 100.

According to this embodiment of the invention, the locking element 212 comprises a pair of jaws pivotally mounted to the housing 202. Each of the jaws has an engagement projection 214 at one end arranged to engage with a locking element 312 of the terminal base 300 which is a slot as will be discussed in more detail below. The engagement projection 214 has an abutment surface having a wedge-shape cross-section to facilitate the locking element 212 to move from the closed position towards the open position during coupling with the locking element 312 of the terminal base 300. The locking mechanism 210 further has a biasing member 216 which couples with the other end of each of the jaws to bias the jaws to the closed position. In this embodiment, the biasing member 216 is a spring, and such mechanism ensures that the terminal block 200 cannot be inadvertently pulled off or decoupled from the terminal base 300 once installed. Alternatively, a single jaw may be used instead and the jaw would work and function the same way. A pair of jaws may be more preferable as the pair of jaws offer a larger degree of security. In other embodiments, other locking elements may be used, for example, a bayonet lock or mount. The magnetic materials of both parts enable easy and controlled alignment and contact of the terminal block and terminal base, and the locking mechanism prevents any unwanted movement of the terminal block away from the terminal base.

Preferably the terminal base and the terminal block have physically complementary shapes to facilitate their physical coupling in a controlled and desired configuration. For example, as more clearly shown in FIG. 2B, the housing 202 of the terminal block 200 has a cavity 220 arranged to couple with a protrusion 320 of the terminal base 300 having a complementary shape to guarantee the correct orientation when coupled together. The magnetic material 206 is disposed within the cavity 220 of the housing 202 to allow the magnetic material 206 to be attracted to the magnetic material 306 disposed on the terminal base 300 of the loudspeaker 100. Advantageously, the shape of the cavity 220 of the terminal block 200 and the protrusion 320 is of an irregular shape such as a trapezium or a rhombus to ensure that the installers do not accidentally rotate the terminal block 200 and incorrectly connect the respective electrical contacts of the terminal block 200 to the terminal base 300 of the loudspeaker 100, for example the positive contact to the negative contact. Alternatively, other mistake-proof mechanisms may be implemented such as having a pin, pip or other element that interferes when connected incorrectly. In other embodiments, the electrical contacts could be arranged asymmetrically within an otherwise symmetrical assembly such that an electrical connection is not enabled if the terminal block is connected to the terminal base incorrectly.

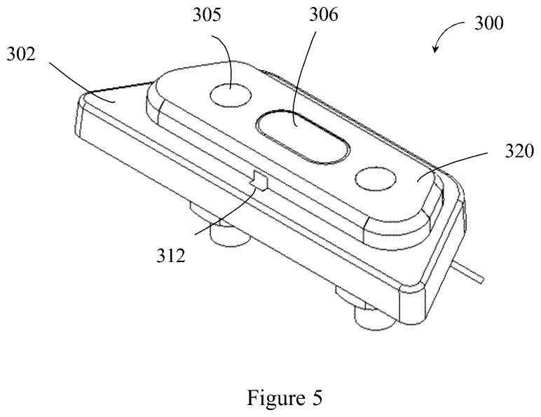

FIG. 5 shows a perspective view of a terminal base 300 of the loudspeaker 100 for connection with a terminal block 200 to receive an electrical signal according to one embodiment of the invention. In this embodiment, the terminal base 300 is positioned at the rear, lateral side of the loudspeaker 100. The terminal base 300 has a housing 302 configured to couple with the terminal block 200. The housing 302 is made of plastic but could also be made of other materials. In this embodiment, the housing 302 has two electrical contacts each configured to receive an electrical signal from a respective electrical contact of the terminal block 200 when the terminal base 300 is coupled with the terminal block 200.

The housing 302 further has a magnetic material 306 for magnetically attracting the terminal block 200. Similar to the terminal block 200, the magnetic material 306 of the terminal base 300 may be is a magnet or a ferromagnetic material. In the preferred embodiment, the magnetic material of the terminal block 200 and the terminal base 300 are both a magnet for a stronger attraction.

The housing 302 further has a locking mechanism 310 comprising a locking element 312 for releasably engaging with a locking element 212 of the terminal block 200. In this embodiment, the locking element 312 is a slot on each side dimensioned to receive the respective engagement projection 214 of the jaws of the terminal block 200. In the embodiment where there is only a single jaw, only one slot may be provided to the housing 302 of the terminal base 300.

The housing 302 defines a protrusion 320 arranged to couple with the cavity 220 of the terminal block 200 having a complementary shape. Preferably, the cross-section of the protrusion 320 is of an irregular shape such as a trapezium or a rhombus to guarantee correct orientation of the coupling between the terminal block 200 and the terminal base 300. Advantageously, the protrusion 320 has a distal portion, wherein the magnet and the electrical contacts are disposed on the distal portion of the protrusion 320.

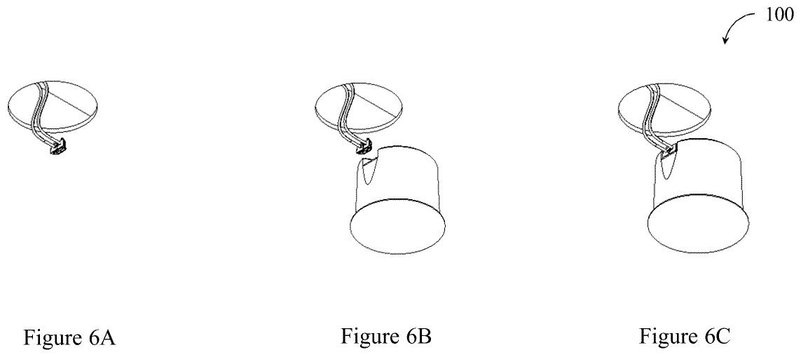

FIGS. 6A to 6C illustrate a method of installing an in-ceiling or in-wall loudspeaker 100. First, the installer provides a wire to the wire-securing terminal of the terminal block and securing the wire therein. The wire may be secured by applying force to the spring-loaded push terminal, inserting the wire into the wire-securing terminal and releasing the force thereby securing the wire. Depending on how many wires and wire-securing terminals are required, the installers may need to repeat the first step a couple of times. By wire, we mean a wire or cable which can provide an electrical signal. Next, the installer provides the terminal base of the loudspeaker in close proximity to the terminal block such that the magnetic material of the terminal base and the terminal block magnetically attract each other to facilitate the coupling of the terminal base with the terminal block to bring the respective electrical contacts into electrical communication with each other. During the coupling of the terminal block with the terminal base due to the magnetic attraction, the locking element of the terminal block moves from the default closed position to the open position temporarily due to the contact with the protrusion of the terminal base at the engagement projection of the jaws. Once the engagement projections of the jaws reach the slot of the terminal base, the engagement projections engage with the slots of the terminal base by sliding into the slots and the pair of jaws of the terminal block returns to its default closed position, and thereby locking the terminal block and the terminal base together.

Optionally, the locking mechanism further has a releasable element for decoupling the locking elements of the terminal block and the terminal base. The releasable element may be a latch on the jaws such that when one applies pressure to the latch, the latch biases the spring connecting the jaws and the jaws move from the closed position to the opened position, thus releasing the engagement between the terminal block and the terminal base. The releasable element may not be present in some embodiments to intentionally prevent accidental disengagement of the terminal block from the terminal base of the loudspeaker.

Although not shown in Figures, in other embodiments, the locking element of the terminal base may comprise the pair of jaws or the single jaw, and the locking element of the terminal block may comprise the slots or slot instead. A skilled person would understand that such alternative configuration would work and function the same way as described above.

While the presence of the magnetic material on the terminal block and the terminal base facilities the coupling of the two, in some embodiments, the magnetic material may not be present. In the case where the magnetic material is absence, installers can still be able to install the loudspeaker by manually bringing the terminal block to couple with the terminal base, without the assistance of magnetic attraction.

In the embodiments shown in Figures, the terminal block and the terminal base are positioned at the rear, lateral side, but in other embodiments, the terminal base may be positioned on an accessory of the loudspeaker such as a pre-construction bracket and the terminal block may be coupled to the terminal base of the pre-construction bracket.

By providing a terminal block and terminal base to an in-ceiling or in-wall loudspeaker, the present invention provides an easy and quick connection of the wires to the loudspeaker while simplifying and allowing a safe installation process by removing the need to support the weight of the speaker while fitting the speaker wires.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

What is claimed is:

1. A terminal block for connection with a terminal base of a loudspeaker to provide an electrical signal to the loudspeaker, comprising
a housing configured to couple with the terminal base of the loudspeaker; the housing comprising:
at least two wire-securing terminals each arranged to receive and secure a wire, each of the at least two wire-securing terminals in electrical communication with an electrical contact for transmitting the electrical signal to a respective electrical contact of the loudspeaker when the terminal block is coupled with the terminal base;
a magnetic material for magnetically attracting the terminal block to the terminal base; and
a locking mechanism comprising a locking element for releasably engaging with a locking element of the terminal base,
wherein the locking element of the terminal block is moveable between an open position and a closed position, wherein in the open position the locking element is not locked with the terminal base of the loudspeaker, and in the closed position the locking element is locked with the terminal base of the loudspeaker,
wherein the locking element of the terminal block comprises a single jaw or a pair of jaws pivotally mounted to the housing, each of the jaws comprising an engagement projection arranged to engage with the locking element of the terminal base,
wherein the engagement projection comprises an abutment surface to facilitate the locking element to move from the closed position towards the open position during coupling with the locking element of the terminal base,
wherein the jaws are biased to the closed position.

2. The terminal block of claim 1, wherein the magnetic material is a magnet or a ferromagnetic material.

3. The terminal block of claim 1, wherein the housing of the terminal block comprises a cavity arranged to couple with a protrusion of the terminal base having a complementary shape.

4. The terminal block of claim 3, wherein the magnetic material is disposed within the cavity of the housing.

5. A terminal base of a loudspeaker for connection with a terminal block, as defined in claim 1, to receive an electrical signal, comprising:
a housing configured to couple with the terminal block; the housing comprising:
at least two electrical contacts each configured to receive an electrical signal from a respective electrical contact of the terminal block when the terminal base is coupled with the terminal block;
a magnetic material for magnetically attracting the terminal block; and
a locking mechanism comprising a locking element for releasably engaging with a locking element of the terminal block.

6. The terminal base of claim 5, wherein the locking element of the terminal base comprises a slot dimensioned to receive the locking element of the terminal block.

7. The terminal base of claim 5, wherein the housing defines a protrusion arranged to couple with a cavity of the terminal block having a complementary shape.

8. The terminal base of claim 7, wherein the protrusion comprises a distal portion, wherein the magnet and the at least two electrical contacts are disposed on the distal portion of the protrusion.

9. A loudspeaker comprising a terminal assembly, the terminal assembly comprising:
a terminal block of claim 1; and
a terminal base of claim 5,
wherein the magnetic material of one of the terminal block and the terminal base comprises a magnet.

10. A method of installing a loudspeaker as defined in claim 9, comprising the steps of:
providing a wire to the wire-securing terminal of the terminal block and securing the wire therein;
providing the terminal base of the loudspeaker in close proximity to the terminal block such that the magnetic material of the terminal base and the terminal block magnetically attract each other to facilitate the coupling of the terminal base with the terminal block to bring the respective electrical contacts into electrical communication with each other.

11. The method of claim 10, wherein the locking element of the terminal block engages with the locking element of the terminal base of the loudspeaker when the terminal base is coupled with the terminal block to lock the terminal block and the terminal base together.
